(19) United States
(12) Patent Application Publication
(10) Pub. No.: US 2015/0118357 A1
(43) Pub. Date: Apr. 30, 2015

(54) QUARG-LIKE CHEESE AND MANUFACTURING METHOD THEREOF

(71) Applicants: Benheng Guo, Shanghai (CN); Beihong Mo, Shanghai (CN); Zhenmin Liu, Shanghai (CN); Yongbiao Ling, Shanghai (CN); Hongyan Gao, Shanghai (CN); Shuai Chen, Shanghai (CN); Yuanrong Zheng, Shanghai (CN); Chunquan Shi, Shanghai (CN)

(72) Inventors: Benheng Guo, Shanghai (CN); Beihong Mo, Shanghai (CN); Zhenmin Liu, Shanghai (CN); Yongbiao Ling, Shanghai (CN); Hongyan Gao, Shanghai (CN); Shuai Chen, Shanghai (CN); Yuanrong Zheng, Shanghai (CN); Chunquan Shi, Shanghai (CN)

(73) Assignee: BRIGHT DAIRY & FOOD CO., LTD, Shanghai (CN)

(21) Appl. No.: 14/382,496

(22) PCT Filed: May 25, 2012
(86) PCT No.: PCT/CN2012/076092

§ 371 Date: Sep. 3, 2014

(30) Foreign Application Priority Data
Mar. 2, 2012 (CN) 201210055399.4

(51) Int. Cl. A23C 19/076; A23C 19/032

(52) U.S. Cl. CPC A23C 19/076; A23C 19/0323
USPC 426/40; 426/582

(57) ABSTRACT

A Quarg-like cheese and manufacturing method thereof, the method includes condensing raw milk in vacuum at 40-50° C. until the content of protein reaching 6.0-8.0 wt %, uniformly mixing with cream, homogenizing, conducting heat treatment at 90-95° C. for 5-10 min., then cooling to 30-34° C., to obtain the treated milk. The method also inoculating a lactobacillus starter used for conventional Quarg cheese into the treated milk, and ferments at 30-34° C. for 90-120 min. The mixing conditions during fermentation being are stirring 2-6 min. at 300-600 rpm, stopping for 5-15 min., and alternating the stirring and stopping processes; filling and simultaneously online adding rennet aqueous solution and uniformly mixing, and upon completion of the filling process, fermenting without agitation at 28-32° C. until the pH value is 4.70-4.75, then transferring to a cold storage to be cooled for 8-12 hours.

### CROSS REFERENCE TO RELATED APPLICATIONS

This non-provisional application is a National Stage entry under U.S.C. §371 of International Application No. PCT/CN2012/076092 filed on May 25, 2012, which claims priority to Patent Application No. 201210055399.4 filed in China on Mar. 2, 2012. The entire contents of all of the above applications are hereby incorporated by reference.

### FIELD OF INVENTION

The present invention relates to a Quarg-like cheese and manufacturing method thereof.

### PRIOR ARTS

Cheese is a kind of nutritious food which is obtained by draining off the whey after adding a starter and rennet to the milk to ferment nutritious material in the milk to mature. Per kilogram of cheese is concentrated by 10 kilograms milk, which contains natural calcium. The process is a concentration process of milk protein, the protein content of cheese is higher than that of the used raw materials.

Quarg cheese is milk-white or pale yellow, which has a taste of fresh or moderate acidity, soft texture, slight elasticity, good spreadability, no separation of water or whey, and no appearance of dry or grain too. Generally speaking, Quarg cheese with good quality is smooth and has a good spread-ability. And the products are stable during a shelf-life of 2-4 weeks when stored <8° C. Herein, the stability means the following cases will not be occurred: (1) microbial pollution, (2) whey separation (namely syneresis), (3) granular texture formation, (4) a phenomenon of overly acidic or bitter substances.

Traditional manufacturing techniques of Quarg cheese, which schematic process is shown in FIG. 1, includes processes of raw milk treatment, mesophilic bacteria fermentation, rennet addition, curd breaking, whey separation and cooling down for packaging, etc. Long production cycle, various processing equipment, large area occupied and high investment in the traditional manufacturing techniques restricts the production of Quarg cheese in factories without a specialized assemblyline. This present situation is urgent to be solved.

### CONTENT OF THE PRESENT INVENTION

The present invention fills in the blank of the existing technology, using the existing equipment of the dairy factories and requiring no additional investment for equipment, to develop a manufacturing method of Quarg-like cheese. The prepared products have a similar flavor and texture to Quarg cheese and are smooth, solid, dedicate with no separation of whey. And the flavor and the state of the products are consistent between batches, and the products have a longer shelf-stable life, and the texture is stable in the shelf life.

The inventors of the present invention have tried to produce the Quarg-like cheese without cutting, and draining the whey in the process of research and development. And, the inventors found that the current processing methods of fresh no-whey-drained cheese are mainly accomplished by adding casein or milk protein which plays a role in texture, as well as milk powder and sugar to supply lactoprotein and milk solids, meanwhile using the process of transfer from a fermentation tank to a storage tank similar to the fermentation of yogurt to realize the preparation of the fresh cheese without draining the whey. However, it is obvious that such processing method is not suitable for Quarg cheese products for the following reasons: first, a real cheese product is produced only by coagulating and condensing the milk without sugar, milk powder and the like; second, it often causes a large amount of whey separation, great damage of hardness of curd if stirring and transferring to a storage tank is still carried out after the rennet was added, and leads to the texture of product much closer to the yogurt with higher viscosity while greatly different from the structure characteristics of cheese. Moreover, up to 16 hours' fermentation is much easier to cause contamination and further shorten the shelf-life of product. In addition, curd will be quickly generated in 15 minutes after rennet is added to raw milk. If the rennet is added in the fermentation tank, the forepart product and the latter product during the filling process will have great differences in the texture for the filling process is always last over 15 minutes. Especially, the latter product will be partially coagulated in the fermentation tank, and the curd will be destroyed when filling by pump. A large number of experiments ended in failure.

In the end, the inventors obtained the manufacturing method of Quarg-like cheese on the basis of unremitting efforts by adjusting and integrating the process parameters, as well as coordinating specific operating conditions with synergistic effects.

In the present invention, the manufacturing method of Quarg-like cheese comprises the following steps:

(1) concentrating raw milk in vacuum at 40-50° C. until the content of protein reaching 6.0-8.0 wt %, uniformly mixing with cream, homogenizing, conducting heat treatment at 90-95° C. for 5-10 min., then cooling to 30-34° C. to obtain treated milk;

(2) inoculating a lactobacillus starter used for traditional Quarg cheese into the treated milk, and fermenting at 30-34° C. for 90-120 min., the mixing conditions during fermentation being: stirring 2-6 min. at 300-600 rpm, stopping for 5-15 min., and alternating the stirring and stopping processes;

(3) filling and simultaneously online adding rennet aqueous solution and uniformly mixing, and upon completion of the filling process, fermenting without agitation at 28-32° C. until pH value reaching 4.70-4.75, then transferring to a cold storage to be cooled for 8-12 hours.

In the present invention, the Quarg cheese belongs to a kind of soft, fresh cheese; wherein, the fresh cheese refers to a directly edible cheese without mature, the shelf life of which is short; the soft cheese is divided by moisture content. Generally, the moisture content in non-fat milk solids is >61 wt % (BenhengGuo, Cheese [M], 2004, P5). The Quarg cheese has milk-white, or pale yellow color, fresh flavors, mild acidity, soft texture, slight elasticity, good spreadability, and no separation of water or whey, and no appearance of dry or grain too.

The manufacturing method of Quarg-like cheese in the present invention is described in details below:

(1) concentrating raw milk in vacuum at 40-50° C. until the content of protein reaching 6.0-8.0 wt %, uniformly mixing with cream, homogenizing, conducting heat treatment at 90-95° C. for 5-10 min., then cooling to 30-34° C. to obtain treated milk.

In the present invention, the raw milk is the commonly used raw milk in this field, preferably is untreated fresh milk; the kind of the raw milk are commonly used in this field, generally selected from cow milk.

In the present invention, concentrating in vacuum can operate according to the conventional operation in this field. The equipment used for vacuum concentration is a single-effect falling film evaporator or a double-effect falling film evaporator.

In the present invention, the cream is liquid milk with fat content of 36-40 wt %, which looks relatively thick. The cream can be used to supplement milk fat, and a preferable dosage of which is 0%-5%, the percentage is a mass percentage of the cream to the total mass of the raw milk treated by vacuum concentration.

In the present invention, the homogenizing is operated according to the conventional operation in this field, preferably double-stage homogenization. Total pressure of the homogenizing preferably is 12 MPa-18 MPa; temperature is the commonly homogenization temperature in this field, generally 65-75° C.

In the present invention, the condition of the heat treatment is preferably at 93-95° C. for 5-8 min.

In the present invention, the condition of the heat treatment is particularly selected, which has an important effect not only on cheese's coagulating and textural forming but also on the shelf-life and safety.

(2) Inoculating a lactobacillus starter used for traditional Quarg cheese into the treated milk, and fermenting at 30-34° C. for 90-120 min., the mixing conditions during fermentation being: stirring 2-6 min. at 300-600 rpm, stopping for 5-15 min., and alternating the stirring and stopping processes.

In the present invention, the lactobacillus starter used for traditional Quarg cheese is commonly used in the preparation of Quarg cheese in this field; the preferable strains are Lactococcus lactis subsp. lactis and Lactococcus lactis subsp. cremoris. The lactobacillus starter preferably is R-704 starter from CHr. Hansen Corporation, MA014 starter from Danisco Corporation or LL-50 starter from DSM Corporation.

In the present invention, a dosage of the lactobacillus starter used for traditional Quarg cheese is the common usage of the lactobacillus starter in traditional Quarg cheese field, however, combining the particular processing conditions of the present invention, the dosage of the lactobacillus starter used for traditional Quarg cheese preferably is 0.002%-0.003 wt %, the percentage is a mass percentage of the lactobacillus starter used for traditional Quarg cheese to the total mass of the treated milk.

In the present invention, fermenting at 30-34° C. for 90-120 min. is generally conducted in a fermentation tank, and fermentation temperature of 30-34° C. can be realized by placing the 30-34° C. treated milk obtained in step (1) in the fermentation tank.

In the present invention, the mixing conditions during fermentation preferably are stirring 3-5 min. at 300-400 rpm, stopping for 6-10 min., and alternating the stirring and stopping processes.

(3) Filling and simultaneously online adding rennet aqueous solution and uniformly mixing, and upon completion of the filling process, fermenting without agitation at 28-32° C. until the pH value reaching 4.70-4.75, then transferring to a cold storage to be cooled for 8-12 hours.

In the present invention, the dosage of the rennet is commonly used in this field, preferably is 0.0003%-0.001%, more preferably is 0.0003%-0.0005%, the percentage is a mass percentage of the rennet to the total mass of the treated milk. The rennet aqueous solution is generally a 1-3 wt % aqueous solution prepared by deionized water and kept at 25-28° C. for 15-20 min. before use.

In the present invention, the rennet is commonly used in this field, preferably calf rennet and/or microbial rennet, which are commercial available, for example, from Danisco, CHr. Hansen, DSM Corporation.

In the present invention, online adding rennet aqueous solution can be conducted by a flavor pump (a pump used for flavor dosing) which is commonly used in this field to achieve uniformly mixing online.

In the present invention, the filling can be the conventional operations in this field, generally is filling into a glass, a composite paper-cup or a plastic cup and sealing.

In the present invention, the static fermentation is particularly selected, which has an important effect on the texture of cheese. Generally, fermenting until the pH value reaching pH4.75, and the fermenting time is about 12-16 hours.

In the present invention, the cold storage is the conventional operation in this field, generally is a storage of 4-8° C. After cold storage, the warehouse shifting is in accordance of first-in-first-out principle.

The present invention also provides a Quarg-like cheese prepared by the manufacturing methods mentioned above.

In the present invention, the mentioned optimized conditions can be optionally combined based on the general knowledge in this field to obtain preferred embodiments.

Unless otherwise indicated, the reagents and raw materials used in the present invention are all commercially available.

The positive effects of the present invention are as follows:

1. The manufacturing method of Quarg-like cheese in the present invention is simple and practical, which is suitable for chinese traditional dairy factories and requires no additional investment for equipment by combining the existing equipment, and creative design and research on the process. The manufacturing method displays extremely positive significance for accelerating the localization process of fresh cheese.

2. The products prepared by the manufacturing method in the present invention have similar flavor with Quarg cheese, meanwhile the products are solid, dedicate, smooth, have no whey separation and have similar texture to traditional Quarg cheese. The flavor and the state of the products are consistent between batches and with little fluctuation, and the products have a shelf-life of 6-8 weeks under cold storage.

### BRIEF DESCRIPTION OF THE DRAWINGS

FIG. 1 is a process schematic for manufacturing the traditional Quarg cheese mentioned in the prior art.

### DETAILED DESCRIPTION OF THE PREFERRED EMBODIMENT

Then the present invention is further illustrated by the following embodiments, but is not limited therein.

Unless otherwise indicated, the reagents and raw materials used in the following embodiments are all commercially available.

### Embodiment 1

Raw milk was concentrated in single-effect falling film evaporator (Medium light machine RNJM01-600) at 40° C. until the content of protein reaching 6.5 wt % (mass percent), then uniformly mixed with 3 wt % cream. Double-stage homogenization was conducted under the pressure of 15 MPa at 65-75° C., heat treatment was conducted afterwards at 95° C. for 5 min., then cooled down to 32° C. Treated milk was obtained.

MA014 starter (from Danisco Corporation, strains are Lactococcus lactis subsp. lactis and Lactococcus lactis subsp. cremoris) of 0.002 wt % of total mass of the treated milk was inoculated into the treated milk in the fermentation tank, and fermentation was conducted at 32° C. for 120 min. The mixing conditions during the fermentation were: stirring at 300 rpm for 6 min., stopping for 10 min., and the stirring and stopping processes were alternated. The treated milk after fermentation was pumped to filling equipment. 0.0005 wt % of calf rennet was dissolved in deionized water to prepare a 2 wt % aqueous solution and the solution was kept at 26° C. for 20 min., then transferred to a flavor tank. Rennet aqueous solution was added online simultaneously by a flavor pump and uniformly mixed when filling into glasses. The glasses were sealed and allowed for static fermentation at 31° C. until pH value reaching 4.70, then transferred quickly to a 4° C. storage room for 8 hours.

### Embodiment 2

Raw milk was concentrated in double-effect falling film evaporator (Medium light machine RNJM02-700) at 50° C. until the content of protein reaching 8.0 wt % (mass percent). Double-stage homogenization was conducted under the pressure of 18 MPa at 65-75° C., heat treatment was afterwards conducted 90° C. for 10 min., then cooled down to 32° C. and treated milk was obtained.

R704 starter (from CHr. Hansen Corporation, strains were Lactococcus lactis subsp. lactis and Lactococcus lactis subsp. cremoris) of 0.003 wt % of total mass of the treated milk was inoculated into the treated milk in the fermentation, and fermentation was conducted at 32° C. for 90 min., the mixing conditions during fermentation were: stirring at 400 rpm for 5 min., stopping for 6 min., and the stirring and stopping processes were alternated. The treated milk after fermentation was pumped to filling equipment. 0.001 wt % of calf rennet was dissolved in deionized water to prepare a 1 wt % aqueous solution and the solution was kept at 28° C. for 15 min., then transferred to a flavor tank. Rennet aqueous solution was added online simultaneously by a flavor pump and uniformly mixed when filling into composite paper-cups. The composite paper-cups were sealed and allowed for static fermentation at 32° C. until pH value reaching 4.75, then transferred quickly to a 8° C. cold storage room for 12 hours.

### Embodiment 3

Raw milk was concentrated in single-effect falling film evaporator at 40° C. until the content of protein reaching 6.0 wt % (mass percent), then uniformly mixed with 5 wt % cream. Double-stage homogenization was conducted under the pressure of 18 MPa at 65-75° C., heat treatment was afterwards conducted at 95° C. for 5 min., then cooled down to 34° C. and treated milk was obtained.

LL-50 starter (from DSM Corporation, strains of Lactococcus lactis subsp. lactis and Lactococcus lactis subsp. cremoris) of 0.002 wt % of total mass of the treated milk was inoculated into the treated milk in the fermentation, and fermentation was conducted at 34° C. for 100 min., the mixing conditions during fermentation were: stirring at 600 rpm for 2 min., stopping for 5 min., the stirring and stopping processes were alternated. The treated milk after fermentation was pumped to filling equipment. 0.0008 wt % of calf rennet was dissolved in deionized water to prepare a 1 wt % aqueous solution and the solution was kept at 25° C. for 20 min., then transferred to a flavor tank. Rennet aqueous solution was added online simultaneously by a flavor pump and uniformly mixed when filling into glasses. The glasses were sealed and allowed for static fermentation at 28° C. until pH value reaching 4.70, then transferred quickly to a 6° C. cold storage room for 10 hours.

### Embodiment 4

Raw milk was concentrated in double-effect falling film evaporator at 48° C. until the content of protein reaching of 7.5 wt % (mass percent), then uniformly mixed with 2 wt % cream. Double-stage homogenization was conducted under the pressure of 12 MPa at 65-75° C., heat treatment was afterwards conducted at 93° C. for 8 min., then cooled down to 30° C. and treated milk was obtained.

MA014 starter (from Danisco Corporation, strains are Lactococcus lactis subsp. lactis and Lactococcus lactis subsp. cremoris) of 0.003 wt % of total mass of the treated milk was inoculated into the treated milk in the fermentation tank, and fermentation was conducted at 30° C. for 90 min., the mixing conditions during fermentation were: stirring at 400 rpm for 3 min., stopping 15 min., and the stirring and stopping processes were alternated. The treated milk after fermentation was pumped to filling equipment. 0.0006 wt % of calf rennet was dissolving in deionized water to prepare a 3 wt % aqueous solution and the solution was kept at 26° C. for 20 min., then transferred to a flavor tank. Rennet aqueous solution was added online simultaneously by a flavor pump and uniformly mixed when filling into glasses. The glasses were sealed and allowed for static fermentation at 31° C. until pH value reaching 4.72, then transferred quickly to a 4° C. cold storage room for 12 hours.

### Embodiment 5

Raw milk was concentrated in single-effect falling film evaporator at 46° C. until the content of protein reaching 6.9 wt % (mass percent), then uniformly mixed with 3.5 wt % cream. Double-stage homogenization was conducted under the pressure of 15 MPa at 65-75° C., heat treatment was afterwards conducted at 95° C. for 6 min., then cooled down to 33° C. and treated milk was obtained.

R704 starter (from CHr. Hansen Corporation, strains are Lactococcus lactis subsp. lactis and Lactococcus lactis subsp. cremoris) of 0.0025 wt % of total mass of the treated milk was inoculated into the treated milk in the fermentation tank, and fermentation was conducted at 33° C. for 97 min., the mixing conditions during fermentation were: stirring at 300 rpm for 5 min., stopping for 10 min., and the stirring and stopping processes were alternated. The treated milk after fermentation was pumped to filling equipment. 0.0005 wt % of microbial rennet was dissolved in deionized water to prepare a 2 wt % aqueous solution and the solution was kept at 25° C. for 20 min., then transferred to a flavor tank. Rennet aqueous solution was added online simultaneously by a flavor pump and uniformly mixed when filling into glasses. The glasses were sealed and allowed for static fermentation at 30° C. until pH value reaching 4.74, then transferred quickly to a 7° C. cold storage room for 12 hours.

### Embodiment 6

Raw milk was concentrated in double-effect falling film evaporator at 42° C. until the content of protein reaching 7.2 wt % (mass percent), then uniformly mixed with 4 wt % cream. Double-stage homogenization was conducted under the pressure of 15 MPa at 65-75° C., heat treatment was afterwards conducted at 94° C. for 6 min., then cooled down to 32° C. and treated milk was obtained.

LL-50 starter (from DSM Corporation, strains are Lactococcus lactis subsp. lactis and Lactococcus lactis subsp. cremoris) of 0.002 wt % of total mass of the treated milk was inoculated into the treated milk in the fermentation tank, and fermentation was conducted at 32° C. for 115 min., the mixing conditions during fermentation were: stirring at 500 rpm for 4 min., stopping for 12 min., and the stirring and stopping processes were alternated. The treated milk after fermentation was pumped to filling equipment. 0.0003 wt % of microbial rennet was dissolved in deionized water to prepare a 3 wt % aqueous solution and the solution was kept at 27° C. for 15 min., then transferred to a flavor tank. Rennet aqueous solution was added online simultaneously by a flavor pump and uniformly mixed when filling into glasses. The glasses were sealed and allowed for static fermentation at 30° C. until pH value reaching 4.75, then transferred quickly to a 4° C. cold storage room for 12 hours.

### Contrastive Example 1

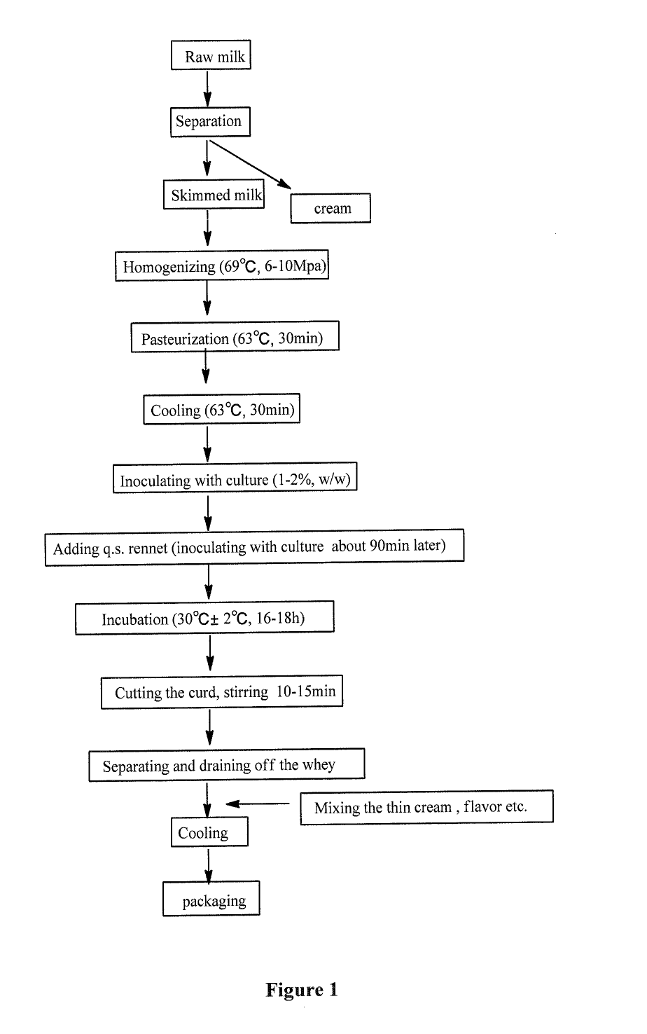

A traditional manufacturing process in the prior art was adopted to prepare Quarg cheese, detailed procedures were shown in FIG. 1.

### Contrastive Example 2

The manufacturing method was the same as embodiment 2 except for the dosage of the calf rennet was 0.002 wt %.

### Effect Embodiment 1

Take a cup of cheese sample and at least 20 volunteers were invited to taste and grade each time. To minimize the interference, red wine was used for gargle before and after tasting. And the specific evaluation criterion and grading criterion are shown in table 1.

TABLE 1
Evaluation criterion of Quarg cheese

| Items | Features | Scores |
|---|---|---|
| Taste and | With a peculiar taste and odor of this kind of cheese, a mild milk | 50 |
| odor (50 | flavor and a fresh acidity | |
| points) | With a peculiar taste and odor of this kind of cheese, a relatively mild | 49-46 |
| | flavor and a slight lower or higher acidity | |
| | With a good taste and odor, but a lighter flavor, a lower or higher | 45-40 |
| | acidity | |
| | With a proper taste and odor, but a lighter flavor, a lower or higher | 39-35 |
| | acidity | |
| | With off-flavor | 34-20 |
| Texture | With an uniform in texture, neither too hard, nor too soft, an | 40 |
| (40 points) | extremely dedicate organization, with no whey separation | |
| | With an uniform in texture, neither too hard, nor too soft, a dedicate | 39-35 |
| | organization , with a small amount of whey separation | |
| | With a basic qualification uniform in texture, slightly soft or hard, a | 34-30 |
| | dedicate configuration, with whey separation | |
| | With a brittle or high elasticity texture, with an obvious whey | 29-20 |
| | separation | |
| Colour | A white colour, smooth, soft and luster | 10 |
| and luster | A slight change in colour and luster | 8-6 |
| (10 points) | An obvious change in colour and luster | 5-0 |

The results are shown in table 2.

TABLE 2
Sensory evaluation data

| | | Contrastive | Contrastive | Embodiment | Embodiment | Embodiment |
|---|---|---|---|---|---|---|
| Index | | example 1 | example 2 | 1 | 2 | 5 |
| Taste and odor | | 45 | 40 | 43 | 46 | 45 |
| Texture | | 36 | 25 | 34 | 35 | 32 |
| Colour | | 8 | 7 | 10 | 9 | 7 |
| Total points | | 89 | 72 | 87 | 90 | 84 |
| Comprehensive | Excellent | 10 | 3 | 10 | 11 | 9 |
| evaluation | Good | 7 | 8 | 8 | 6 | 7 |
| (person-time) | general | 3 | 9 | 2 | 3 | 4 |

The data in table 2 shows: compared with common Quarg cheese, the Quarg-like cheese in the present invention shows a high overall acceptance and has about the same scores in appearance and flavor (Contrastive example 1) and in texture. However, the Quarg cheese prepared by the method in contrastive example 2 has a lower score in texture and also in comprehensive evaluation, which shows that it is hard to get the effects disclosed in the present invention when the products are not prepared according to the method in the present invention. Thus, the Quarg-like cheese in the present invention is favored by the tasters and the process is feasible, which completely meets the demand for commercialization.

### Effect Embodiment 2

The effect evaluation on whey separation was conducted about the Quarg-like cheese in the present invention (Embodiment 1, 3, 6) and contrastive example 1, 2. Cheese samples with similar mass (about 80 g) were filled into same size cylindrical containers (with an area of about 20 cm²) and sealed, placed in a 10° C. refrigerator for 5 days, then unsealed and the total mass of the sample and packaging W₁, the mass of empty packaging Wₚ and the mass of the collected whey separated on the surface of cheese W₂ are weighed, and 5 parallel samples are taken for each sample.

The amount of whey separated on the surface (%)=[W₂/(W₁−Wₚ)]*100%

The results are shown as below:

| | The amount of whey |
|---|---|
| Samples | separation on the surface (%) |
| Contrastive example 1 | 0.08 ± 0.14^{b} |
| Embodiment 1 | 0.14 ± 0.12^{b} |
| Embodiment 3 | 0.09 ± 0.07^{b} |
| Embodiment 6 | 0.06 ± 0.05^{b} |
| Contrastive example 2 | 0.75 ± 0.17^{a} |

Note:
average ± standard deviation, in same column, same letter represents no significant difference, otherwise represents significant difference (p < 0.05).

The above figures show that compared with contrastive example 1, three embodiments have no significant difference and the amount of separated whey is in a normally acceptable range. Contrastive example 2 has a significant difference, and the product in contrastive example 2 has obvious whey separation, which affects the market ability. Therefore, the Quarg cheese in the present invention compared with the traditional Quarg cheese not only exhibits similar flavor and taste but also shows similar property of whey separation.

### Effect Embodiment 3

Evaluation on shelf-life was conducted about the Quarg-like cheese in the present invention (Embodiment 1, 4, 5) and contrastive example 1. Microbiological analysis results are as index (microbial limited by China national standard GB5420, especially the index of molds and yeasts) for contrast. Take 10 cups every 10 days to examine the appearance and microbes and record the number of unqualified products.

| | The | The | The | The | The | The | The |
|---|---|---|---|---|---|---|---|
| | 10^{th} | 20^{th} | 30^{th} | 40^{th} | 50^{th} | 60^{th} | 70^{th} |
| Samples | day | day | day | day | day | day | day |
| Contrastive | 0 | 0 | 1 | 4 | 8 | 9 | 10 |
| example 1 | | | | | | | |
| Embodiment 1 | 0 | 0 | 0 | 0 | 0 | 0 | 3 |
| Embodiment 4 | 0 | 0 | 0 | 0 | 0 | 1 | 4 |
| Embodiment 5 | 0 | 0 | 0 | 0 | 0 | 0 | 2 |

The above figures show that, only one case of the Quarg cheese in the present invention is unqualified after 60 days while 90% of the products in contrastive example 1 have gone bad. It can be seen that the shelf-life of the Quarg-like cheese in the present invention is obviously longer than that of common Quarg cheese.

1. A manufacturing method of Quarg-like cheese, comprising the following steps:
(1) concentrating raw milk in vacuum at 40-50° C. until the content of protein reaching 6.0-8.0 wt %, uniformly mixing with cream, homogenizing, conducting heat treatment at 90-95° C. for 5-10 min., then cooling to 30-34° C. to obtain treated milk;
(2) inoculating a lactobacillus starter used for traditional Quarg cheese into the treated milk, and fermenting at 30-34° C. for 90-120 min., the mixing conditions during fermentation being: stirring 2-6 min. at 300-600 rpm, stopping for 5-15 min., and alternating the stirring and stopping processes;
(3) filling and simultaneously online adding rennet aqueous solution and uniformly mixing, and upon completion of the filling process, fermenting without agitation at 28-32° C. until pH value reaching 4.70-4.75, then transferring to a cold storage to be cooled for 8-12 hours.

2. The manufacturing method according to claim 1, wherein in step (1), the raw milk is untreated fresh milk; the kind of the raw milk is cow milk.

3. The manufacturing method according to claim 1, wherein in step (1), an equipment used for vacuum concentration is a single-effect falling film evaporator or a double-effect falling film evaporator.

4. The manufacturing method according to claim 1, wherein in step (1), the dosage of the cream is 0-5%, the percentage is a mass percentage of the cream to the total mass of the raw milk treated by vacuum concentration; the homogenizing is double-stage homogenization; the heat treatment is conducted at 93-95° C. for 5-8 min.

5. The manufacturing method according to claim 1, wherein in step (2), the strain of the lactobacillus starter used for traditional Quarg cheese is Lactococcus lactis subsp. lactis and/or Lactococcus lactis subsp. cremoris.

6. The manufacturing method according to claim 1, wherein in step (2), the mixing conditions during fermentation are: stirring 3-5 min. at 300-400 rpm, stopping for 6-10 min., and alternating the stirring and stopping processes.

7. The manufacturing method according to claim 1, wherein in step (3), the dosage of the rennet is 0.0003-0.001%, the percentage is a mass percentage of the rennet to the total mass of the treated milk; the kind of the rennet is calf rennet and/or microbial rennet.

8. The manufacturing method according to claim 1, wherein in step (3), the online adding rennet aqueous solution is conducted by a flavor pump.

9. The manufacturing method according to claim 1, wherein the filling is filling into a glass, a composite paper cup or a plastic cup and sealing; the cold storage is at 4-8° C., the transferring after the cold storage follows up with a first-in-first-out principle.

10. A Quarg-like cheese prepared by the manufacturing method according to claim 1.

11. The manufacturing method according to claim 1, wherein in step (1), total pressure of the homogenizing is 12 MPa-18 MPa.

12. The manufacturing method according to claim 1, wherein in step (1), the temperature of the homogenizing is 65-75° C.

13. The manufacturing method according to claim 1, wherein in step (2), the lactobacillus starter is R-704 starter from CHr. Hansen Corporation, MA014 starter from Danisco Corporation or LL-50 starter from DSM Corporation.

14. The manufacturing method according to claim 1, wherein in step (2), the dosage of the lactobacillus starter used for traditional Quarg cheese is 0.002%-0.003 wt %, the percentage is a mass percentage of the lactobacillus starter used for traditional Quarg cheese to the total mass of the treated milk.

15. The manufacturing method according to claim 7, wherein in step (3), the dosage of the rennet is 0.0003-0.0005%.

16. The manufacturing method according to claim 1, wherein the rennet aqueous solution is a 1-3 wt % aqueous solution prepared by deionized water and kept at 25-28° C. for 15-20 min. before use.
